(19) United States
(12) Patent Application Publication
(10) Pub. No.: US 2023/0034684 A1
(43) Pub. Date: Feb. 2, 2023

(54) ELECTRIC VEHICLE CHARGING MANAGEMENT METHODS AND SYSTEMS CAPABLE OF INTEGRATING MULTIPLE IDENTITIES

(71) Applicant: Noodoe Corporation, Taipei City (TW)

(72) Inventors: Yi-An Hou, Taipei City (TW); Ming-San Huang, Taipei City (TW); En-Yu Shih, Taipei City (TW); Yu-Ting Liou, Taipei City (TW); Chun-Hung Kung, Taipei City (TW)

(21) Appl. No.: 17/705,466

(22) Filed: Mar. 28, 2022

(30) Foreign Application Priority Data
Jul. 30, 2021 (TW) 110128037

(51) Int. Cl. B60L 53/66; B60L 53/64; B60L 53/65; B60L 53/62

(52) U.S. Cl. CPC B60L 53/665; B60L 53/64; B60L 53/65; B60L 53/62

(57) ABSTRACT

Electric vehicle charging management methods and systems capable of integrating multiple identities are provided. First, a mobile device executes an application, and selects a first identity account from a plurality of identity accounts through the application. Then, a first charging request is generated according to the first identity account and a first charging station, and the first charging request is transmitted to the server via a network through the mobile device or the first charging station. In response to the first charging request, the server instructs the first charging station to perform a first charging operation via the network. Thereafter, the server continuously obtains first charging state information of the first charging operation from the first charging station via the network, and calculates a first charging fee associated with the first identity account based on the first charging state information.

### BACKGROUND OF THE INVENTION

### Field of the Invention

The disclosure relates generally to charging management methods and systems for electric vehicles, and, more particularly to electric vehicle charging management methods and systems capable of integrating multiple identities.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

With the gradual improvement of charging supporting measures, various car manufacturers are also actively launching various styles of electric vehicles to seize the business opportunities of electric vehicles, making many consumers buy electric vehicles and many enterprises such as passenger bus companies and logistics companies also have adopted electric vehicles as official vehicles to carry out businesses. Generally, an electric vehicle user can use a personal account to perform a charging operation at a charging station, and the charging fee corresponding to the charging operation is paid by the user himself. An enterprise can provide specific users such as company employees with an enterprise account, and specific users can use the enterprise account to perform charging operations at the charging station, and the charging fee corresponding to the charging operation is paid by the enterprise.

Currently, most charging station operators develop their applications, and their users can use the applications to inquire the location of charging stations, start charging operations, and check charging progress. In addition to personal accounts, some car owners may also have other accounts such as business accounts. However, when a user has multiple accounts at the same time, the use of multiple accounts may require switching between different applications and the payment methods of charging fees are also different. If the accounts in different applications cannot be effectively integrated, resulting in difficulties in use management, causing great distress to car owners, and reducing users' fluency and satisfaction in using related services. In addition, for enterprises, since the charging fee of the enterprise account is paid by the enterprise, the administrative cost of paying each charging fee will be a huge burden for the enterprise. Therefore, how to effectively prevent the enterprise account from being charged stealthily and pursue the maximum profit of the enterprise become a latest issue in the industry.

### BRIEF SUMMARY OF THE INVENTION

In an embodiment of an electric vehicle charging management method capable of integrating multiple identities are provided. First, a mobile device executes an application, and selects a first identity account from a plurality of identity accounts through the application. Then, a first charging request is generated according to the first identity account and a first charging station, and the first charging request is transmitted to the server via a network through the mobile device or the first charging station. In response to the first charging request, the server instructs the first charging station to perform a first charging operation via the network. Thereafter, the server continuously obtains first charging state information of the first charging operation from the first charging station via the network, and calculates a first charging fee associated with the first identity account based on the first charging state information, wherein the first charging state information comprises a charging time or a charging amount.

An embodiment of an electric vehicle charging management system capable of integrating multiple identities comprises a mobile device, a plurality of electric vehicle charging stations, and a server. The mobile device executes an application, and selects a first identity account from a plurality of identity accounts through the application. Each electric vehicle charging station has a network connection capability, and connects to the server through a network. The server receives a first charging request which is generated according to the first identity account and a first charging station among the electric vehicle charging stations. In response to the first charging request, the server instructs the first charging station to perform a first charging operation via the network, continuously obtains first charging state information corresponding to the first charging operation from the first charging station via the network, and calculates a first charging fee associated with the first identity account based on the first charging state information, wherein the first charging state information comprises a charging time or a charging amount.

In some embodiments, the server further determines whether the first identity account belongs to an enterprise account or a personal account, associates the first charging fee with the enterprise account, and periodically generates billing information corresponding to the enterprise account according to at least the first charging fee when the first identity account belongs to the enterprise account.

In some embodiments, the server further provides a payment interface for setting payment information for the first charging fee before or after the first charging operation is performed when the first identity account belongs to the personal account.

In some embodiments, the server further pays the first charging fee according to a stored value amount or payment information when the first identity account belongs to the personal account.

In some embodiments, the server further provides a list of candidate charging stations, determines whether the first charging station is in the list of the candidate charging stations, and generates a warning message, or prohibits the execution of the first charging operation when the first charging station is not in the list of the candidate charging stations.

In some embodiments, the candidate charging stations are determined according to a moving route corresponding to the mobile device.

In some embodiments, the server further determines whether a time for receiving the first charging request falls within a duty period, and generates a warning message, or prohibits the execution of the first charging operation when the time for receiving the first charging request does not fall within the duty period.

In some embodiments, the server further receives a second charging request via the network during the execution of the first charging operation, wherein the second charging request is based on a second identity account and a second charging station among the electric vehicle charging stations, determines whether the second identity account is the same as the first identity account by the server, and generates a warning message, or prohibits the execution of the second charging operation on the second charging station when the second identity account is the same as the first identity account.

In some embodiments, the server further receives a third charging request via the network, wherein the third charging request is generated according to a third identity account and a third charging station among the electric vehicle charging stations, determines whether the third identity account belongs to the enterprise account by the server, associates a third charging fee for a third charging operation corresponding to the third charging request to the enterprise account, and periodically generates the billing information corresponding to the enterprise account according to at least the first charging fee and the third charging fee when the third identity account belongs to the enterprise account.

Electric vehicle charging management methods capable of integrating multiple identities may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electric vehicle charging management system capable of integrating multiple identities of the invention;

FIG. 2 is a schematic diagram illustrating an embodiment of an electric vehicle charging station of the invention;

FIG. 3 is a schematic diagram illustrating an embodiment of a server of the invention;

FIG. 4 is a schematic diagram illustrating an embodiment of a mobile device of the invention;

FIG. 5 is a flowchart of an embodiment of an electric vehicle charging management system capable of integrating multiple identities of the invention;

FIG. 6 is a flowchart of another embodiment of an electric vehicle charging management system capable of integrating multiple identities of the invention;

FIG. 7 is a flowchart of another embodiment of an electric vehicle charging management system capable of integrating multiple identities of the invention;

FIG. 8 is a flowchart of another embodiment of an electric vehicle charging management system capable of integrating multiple identities of the invention; and

FIGS. 9A and 9B show a flowchart of another embodiment of an electric vehicle charging management system capable of integrating multiple identities of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

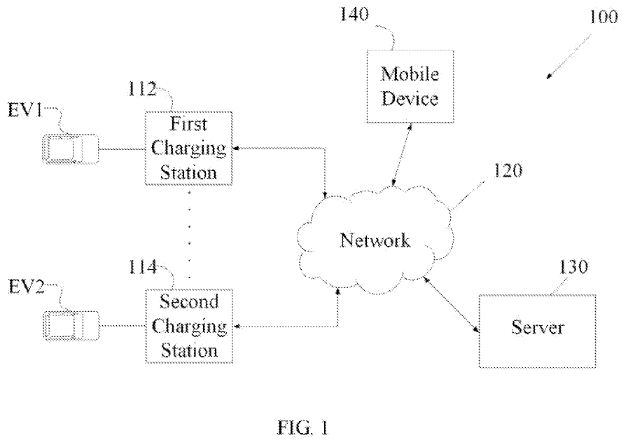

FIG. 1 is a schematic diagram illustrating an embodiment of an electric vehicle charging management system capable of integrating multiple identities of the invention. The electric vehicle charging management system capable of integrating multiple identities 100 comprises a plurality of electric vehicle charging stations, such as a first charging station 112 and a second charging station 114, a server 130 respectively connected with the first charging station 112 and the second charging station 114 via a network 120, and a mobile device 140. The respective charging stations can provide electric vehicles (EV1, EV2) for charging operations. In some embodiments, the network 120 may be a wired network, a telecommunication network, and a wireless network, such as a Wi-Fi network. The server 130 can respectively receive various data from the first charging station 112 and the second charging station 114, and transmit related signals to the first charging station 112 and the second charging station 114. The first charging station 112 and the second charging station 114 can perform related operations according to the signals received from the server 130. For example, when the electric vehicle EV1 is coupled to the first charging station 112 through a charging gun of the first charging station 112 for a charging operation, the first charging station 112 can continuously transmit charging information corresponding the charging operation of the electric vehicle EV1 via the network 120, and the server 130 can receive the charging information of the corresponding charging operation from the first charging station 112 via the network 120. Similarly, when the electric vehicle EV2 is coupled to the second charging station 114 through a charging gun of the second charging station 114 to perform a charging operation, the second charging station 114 can continuously transmit the charging information corresponding the charging operation of the electric vehicle EV2 via the network 120, and the server 130 can receive the charging information of the corresponding charging operation from the second charging station 114 via the network 120. In some embodiments, the charging information may include at least a charging start time, a charging period, an output power, and/or related information indicating whether a load adjustment operation is being performed. The server 130 can know the usage status of the corresponding electric vehicle charging station according to the charging information.

It is noted that the user can connect the electric vehicle EV1 and the first charging station 112 to each other, such as inserting a charging gun into the charging port of the electric vehicle to send a charging request corresponding to the first charging station 112 to use the first charging station 112. The first charging station 112 performs a charging operation for the electric vehicle EV1. Similarly, the user can connect the electric vehicle EV2 and the second charging station 114 to each other, such as inserting a charging gun into the charging port of the electric vehicle to send a charging request corresponding to the second charging station 114 to use the second charging station 114. It is understood that, in some embodiments, the server 130 may directly or indirectly receive a charging request from a mobile device (not shown in FIG. 1) of the owner of the electric vehicle EV1, and generate a charging authorization command based on the charging request and transmit it to the first charging station 112 via the network 120, so that the first charging station 112 outputs power to the electric vehicle EV1, such as an electric scooter or an electric car, which is electrically connected to it, or prohibits the first charging station 112 from outputting power to the electric vehicle EV1. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the first charging station 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use an RFID card to approach an induction area (not shown in FIG. 1) on the first charging station 112 to generate a corresponding charging request, and sent it to the server 130 via the network 120. It is reminded that, in some embodiments, each user can have an RFID card.

It is noted that, the mobile device 140 may be corresponded to the owner of the electric vehicle, which can be any electronic device capable of Internet access, such as mobile devices, such as mobile phones, smart phones, personal digital assistants, global positioning systems, and notebook computers. In some embodiments, the mobile device 140 can receive status information and notifications of the corresponding charging operation from the cloud management server 130 via the network 120. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

It is understood that, the server 130 can perform a load adjustment operation for the electric vehicle charging stations according to at least one energy management scheme. Specifically, the server 130 can generate an instruction and send the instruction to the respective charging station (112, 114) via the network 120 to control the charging station to output power for charging with a specified power parameter, such as a specified amperage, during a specific period of time to the electric vehicle connected to the station, or to prohibit the charging station from outputting power to the electric vehicle.

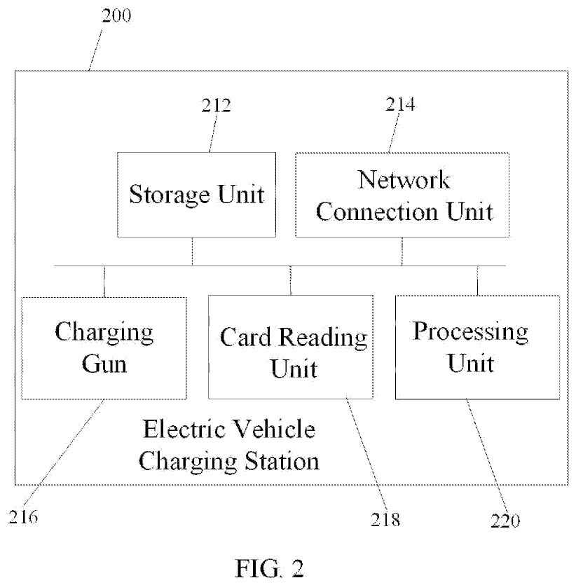

FIG. 2 is a schematic diagram illustrating an embodiment of an electric vehicle charging station of the invention. The electric vehicle charging station 200 shown in FIG. 2 can be applied to the first charging station 112 and the second charging station114 in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, a card reading unit 218, and a processing unit 220. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The card reading unit 218 may be an RFID reading unit for sensing information of a physical card, such as RFID card. The information sensed from the RFID card may be a card identification code and/or a user identification code of the physical card. The processing unit 220 can control the operations of related software and hardware in the electric vehicle charging station 200, and cooperate with the server 130 to execute the methods of the invention. Related details will be described later. It is noted that, in some embodiments, the processing unit 220 may be a general-purpose controller, a Micro-Control Unit, MCU, or a Digital Signal Processor, DSP, etc., to provide functions of data analysis, processing and calculation, but the present invention is not limited to this. In one embodiment, the processing unit 220 may use the network connection unit 214 to transmit the power state of the corresponding electric vehicle through a network for a cloud management server, such as the cloud server 130, for subsequent charging management. In another embodiment, the processing unit 220 can obtain the power parameter of a charging operation from the server 130, determine the output power according to the power parameter received from the server 130, and output the power to at least one electric vehicle through the charging gun 216 to perform the charging operation.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

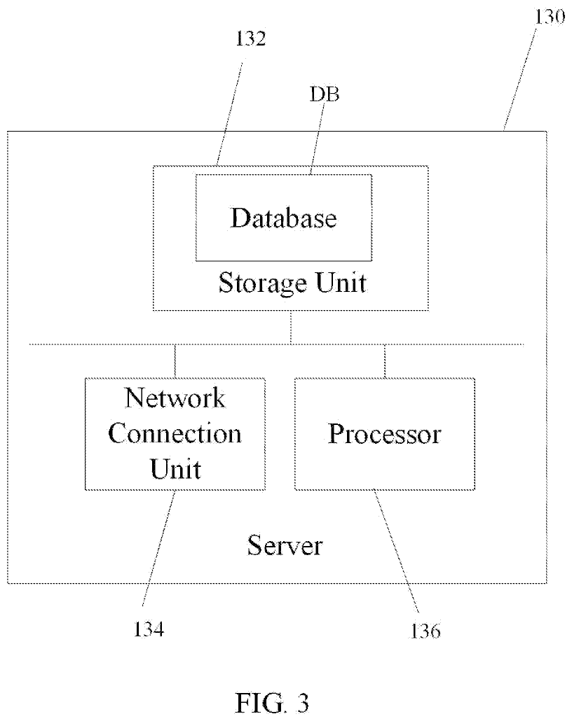

FIG. 3 is a schematic diagram illustrating an embodiment of a server of the invention. As shown in FIG. 3, the server 130 of the invention can be any processor-based electronic device, which comprises at least a storage unit 132, a network connection unit 134, and a processor 136. It is noted that, the server 130 can receive various data corresponding to a plurality of electric vehicle charging stations in a charging field. The server 130 can directly or indirectly receive a charging request from a mobile device or a charging station, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 132 may be a memory, which can store and record related data, such as various data of the electric vehicle charging stations. It is noted that, the storage unit 132 may include a database DB for recording relevant information of a plurality of identity accounts corresponding to a specific user. In some embodiments, the identity account may belong to an enterprise account of an enterprise, and the enterprise can decide whether the enterprise account of a specific user can be charged at specific electric vehicle charging stations, and the corresponding charging fee will be associated to the enterprise. In some embodiments, the enterprise account can also use an interface provided by the server 130 to perform an account reload operation to store a specific amount or bind a payment account information. The charging fee associated with the enterprise account can be paid through this stored value or payment account information. In some embodiments, the identity account may further include vehicle identification data associated with an electric vehicle and its corresponding vehicle-related data, and the charging fee corresponding to the same vehicle data is charged by the owner of the electric vehicle, such as a fleet owner. For example, in one embodiment, when the user is an employee of a fleet and drives a first electric vehicle, the identity account may include a vehicle account corresponding to the vehicle number of the first electric vehicle, but the present invention is not limited to this. In addition, in some embodiments, the identity account may be a personal account of the user, and the charging fee for the corresponding identity account is paid by the user. In some embodiments, the database can also record the user identification code corresponding to a specific user's personal account, and a corresponding stored value amount that can be used for charging. When a specific user performs a charging operation, the charging fee generated by the charging operation can be deducted from the corresponding stored value amount of the specific user. Through the network connection unit 134, the server 130 can be coupled to and communicates with the electric vehicle charging stations (112, 114) via the network 120, such as a wired network, a telecommunications network, and a wireless network, such as a Wi-Fi network, and transmits related data/signals/commands to different electric vehicle charging stations via the network 120 to control whether the electric vehicle charging stations output power, and specify power parameters for outputting power to electric vehicles. The processor 136 can control the operations of related software and hardware in the server 130, and execute the methods of the invention. The relevant details will be described later. It should be noted that, in some embodiments, the processor 136 may be a general-purpose controller, a microcontroller, or a digital signal controller, etc., for providing data analysis, processing and computing functions, but the present invention is not limited to this.

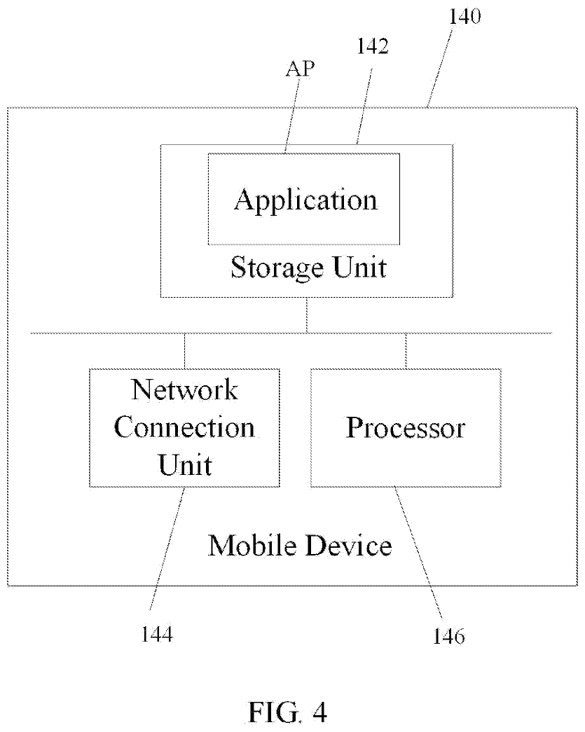

FIG. 4 shows a mobile device according to an embodiment of the present invention. As shown in FIG. 4, the mobile device 140 according to the embodiment of the present invention can be any electronic device capable of Internet access, such as mobile phones, smart phones, personal digital assistants, global positioning systems, and notebook computers. The mobile device 140 comprises a storage unit 142, a network connection unit 144, and a processor 146. The storage unit 142 may be a memory, which can store and record related data, such as one or more identity accounts of a user corresponding to the mobile device 140, and related data received from the server 130 through the network 120, such as the charging state and notifications corresponding to charging operations. In some embodiments, the identity account may belong to an enterprise account of an enterprise, and the charging fee corresponding to the identity account can be paid by the enterprise. In some embodiments, the identity account may further include vehicle identification data associated with an electric vehicle and its corresponding vehicle-related data, and the charging fee corresponding to the same vehicle data is charged by the owner of the electric vehicle, such as a fleet owner. For example, in one embodiment, when the user is an employee of a fleet and drives a first electric vehicle, the identity account may include a vehicle account corresponding to the vehicle number of the first electric vehicle, but the present invention is not limited to this. In addition, in some embodiments, the identity account may be a personal account of the user, and the charging fee for the corresponding identity account is paid by the user.

In some embodiments, the state information and notification may include notifying that the electric vehicle has stopped charging, notifying that the vehicle is being moved, and/or notifying that the charging gun of the electric vehicle charging device has been unplugged from the electric vehicle, and the like. It is reminded that the storage unit 142 may include an application AP. The application AP is used for charging electric vehicles. The application AP may include a user interface through which a charging request may be generated for a specific electric vehicle charging station. In addition, the application program AP may have a scanning function for scanning a two-dimensional identification code, such as a QR code, on a specific electric vehicle charging station to generate the above-mentioned charging request, thereby starting a charging procedure. Through the network connection unit 144, the mobile device 140 can be coupled and communicated with the server 130 through the network 120, such as a wired network, a telecommunication network, and a wireless network, such as a Wi-Fi network. The processor 146 can control the operations of the relevant software and hardware in the mobile device 140, and perform the method of the present invention. The relevant details will be described later. It should be noted that, in some embodiments, the processor 146 may be a general-purpose controller, a Micro-Control Unit (MCU), or a Digital Signal Processor (DSP), etc., for providing data The functions of analysis, processing and calculation, but the present invention is not limited to this.

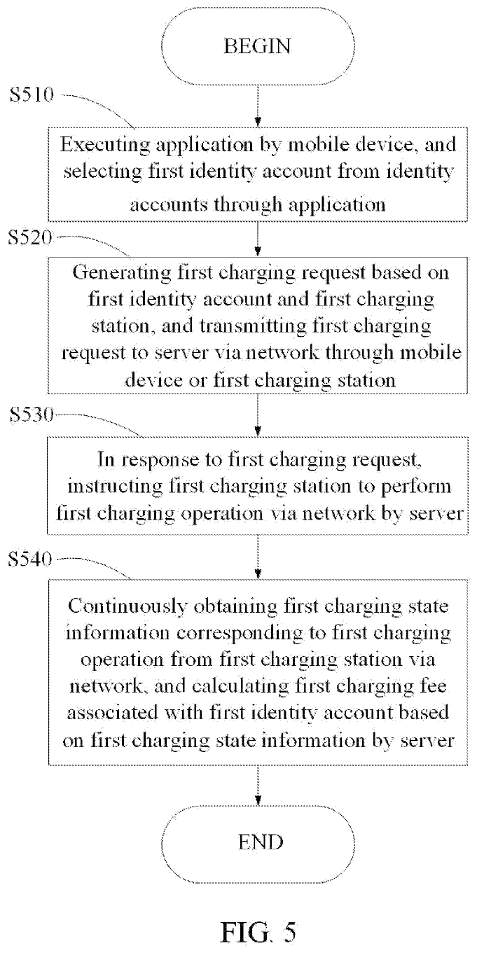

FIG. 5 is a flowchart of an embodiment of an electric vehicle charging management method capable of integrating multiple identities of the invention. The electric vehicle charging management method capable of integrating multiple identities of the invention is applicable to a mobile device, a plurality of charging stations, and a server connected with the respective charging stations via a network.

In step S510, an application is executed on the mobile device, and a first identity account is selected among a plurality of identity accounts through the application. It should be noted that, in some embodiments, the application may include a plurality of identity accounts corresponding to a user, and the identity accounts at least include a first identity account and a second identity account. It is reminded that, in some embodiments, the above-mentioned identity account can be preset in the application. In some embodiments, the identity account may belong to an enterprise account of an enterprise, and the charging fee corresponding to the identity account can be paid by the enterprise. In some embodiments, the identity account may further include vehicle identification data associated with an electric vehicle and its corresponding vehicle-related data, and the charging fee corresponding to the same vehicle data is charged by the owner of the electric vehicle, such as a fleet owner. For example, in one embodiment, when the user is an employee of a fleet and drives a first electric vehicle, the identity account may include a vehicle account corresponding to the vehicle number of the first electric vehicle, but the present invention is not limited to this. In addition, in some embodiments, the identity account may be a personal account of the user, and the charging fee for the corresponding identity account is paid by the user. In some embodiments, the application may include a user interface through which the first identity account and the second identity account can be set, the first identity account or the second identity account can be selected, and a charging request corresponding to a specific electric vehicle charging station can be generated. In step S520, a first charging request is generated according to the first identity account and a first charging station among the electric vehicle charging stations, and the first charging request is transmitted to the server via the network through the mobile device or the first charging station. In some embodiments, the mobile device may execute an application to select a first charging station through the application, thereby generating the first charging request including the charging station identification code of the selected charging station and the first identity account, and transmit the first charging request to the server via the network. It must be noted that, in some embodiments, the mobile device can scan a quick response code, such as a QR code, on the first charging station, and generate the first charging request comprising the charging station identification code of the first charging station and the first identity account according to the quick response code. The first charging request is sent to the server via the network. In some embodiments, the mobile device can select the first charging station through the application, so as to generate the first charging request comprising the charging station identification code of the selected charging station and the first identity account, and transmit the first charging request to the server via the network. After the server receives the first charging request via the network, in step S530, in response to the first charging request, the server instructs the first charging station to perform a first charging operation via the network. Then, in step S540, the server continuously obtains first charging state information corresponding to the first charging operation from the first charging station via the network, and calculates a first charging fee associated with the first identity account according to the first charging state information, wherein the first charging state information comprises a charging time and/or a charging amount. It should be noted that, in some embodiments, the server may calculate the latest first charging fee associated with the first identity account according to the received first charging state information in real time. In some embodiments, the server may calculate the final first charging fee associated with the first identity account according to the first charging state information when receiving a charging end signal of the charging operation. The present invention is not limited to any point in time for calculating the charging fee. That is, the user can use the mobile device to select a specific identity account through the application to start the charging operation at the electric vehicle charging station, and the server can calculate the charging fee associated with the selected identity account.

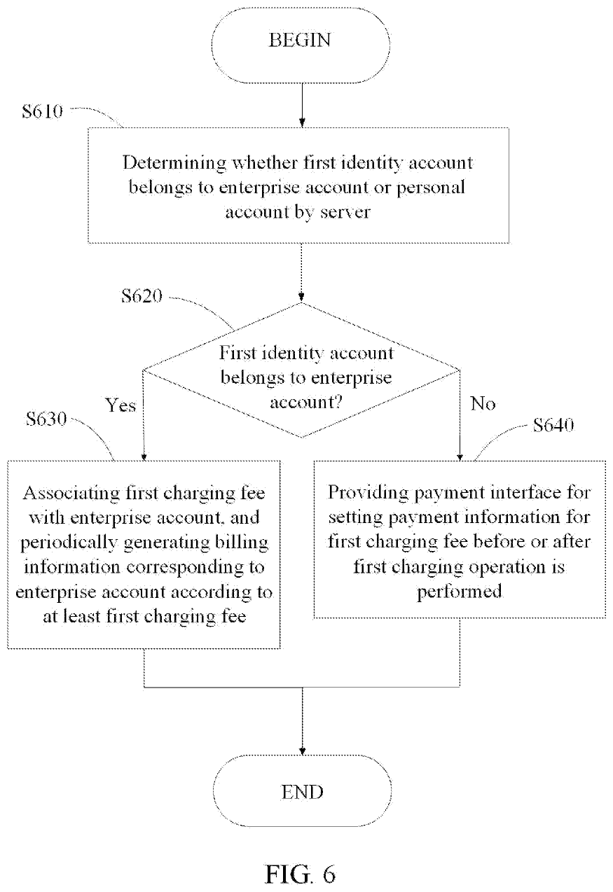

FIG. 6 is a flowchart of another embodiment of an electric vehicle charging management method capable of integrating multiple identities of the invention. The electric vehicle charging management method capable of integrating multiple identities of the invention is applicable to a server connected with the respective charging stations via a network. In this embodiment, the first identity account at least includes an enterprise account and a personal account, and the server can calculate the corresponding charging fee respectively according to whether the first identity account belongs to the enterprise account or the personal account.

First, in step S610, the server determines whether the first identity account belongs to an enterprise account or a personal account. In this embodiment, the first identity account may belong to either an enterprise account or a personal account. When the first identity account belongs to the enterprise account (Yes in step S620), in step S630, the server associates the first charging fee with the enterprise account, and periodically generates a bill information for the enterprise account according to at least the first charging fee. When the first identity account is not an enterprise account (No in step S620), it means that the first identity account belongs to a personal account. In step S640, the server provides a payment interface for setting a payment information before or after the first charging operation is performed, wherein the payment information is used for paying the first charging fee. In some embodiments, the user can perform an account reload operation through an interface such as a user interface of an application of a mobile device in advance to store a specific amount or bind a payment information, then when the first identity account belongs to a personal account, the server can pay the first charging fee according to the stored value or payment information. That is, the charging fee corresponding to the personal account can be paid through this stored value or payment account information.

It is worth noting that, as mentioned above, for enterprises, since the charging fee of the enterprise account is paid by the enterprise, there is an urgent need for an effective method to prevent the enterprise account from being charged stealthily. Therefore, in some embodiments, this case proposes an electric vehicle charging management method that can effectively prevent enterprise accounts from being charged stolen.

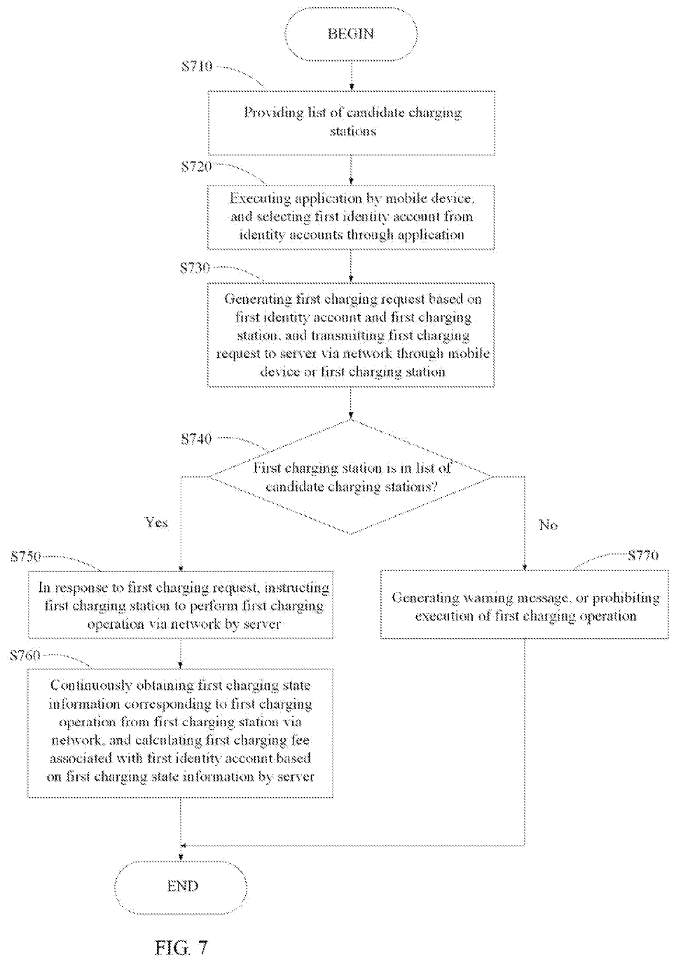

FIG. 7 is a flowchart of another embodiment of an electric vehicle charging management method capable of integrating multiple identities of the invention. The electric vehicle charging management method capable of integrating multiple identities of the invention is applicable to a mobile device, a plurality of charging stations, and a server connected with the respective charging stations via a network. In this embodiment, the first identity account belongs to an enterprise account, and the enterprise account is only allowed to perform charging operations in the charging stations listed in the candidate charging station list.

In step S710, a list of candidate charging stations is provided. The list of the candidate charging stations includes several candidate charging stations. In step S720, an application is executed on the mobile device, and a first identity account is selected from a plurality of identity accounts through the application. It should be noted that, in some embodiments, the application may include a plurality of identity accounts corresponding to a user, and the identity accounts at least include a first identity account and a second identity account. It is reminded that, in some embodiments, the above-mentioned identity account can be preset in the application. In this embodiment, the first identity account belongs to an enterprise account of an enterprise, and the charging fee of the first identity account is paid by the enterprise. In step S730, a first charging request is generated according to the first identity account and a first charging station among the electric vehicle charging stations, and the first charging request is transmitted to the server via the network through the mobile device or the first charging station. In some embodiments, the mobile device may execute an application to select a first charging station through the application, thereby generating the first charging request including the charging station identification code of the selected charging station and the first identity account, and transmit the first charging request to the server via the network. It must be noted that, in some embodiments, the mobile device can scan a quick response code, such as a QR code, on the first charging station, and generate the first charging request comprising the charging station identification code of the first charging station and the first identity account according to the quick response code. The first charging request is sent to the server via the network. In some embodiments, the mobile device can select the first charging station through the application, so as to generate the first charging request comprising the charging station identification code of the selected charging station and the first identity account, and transmit the first charging request to the server via the network. After the server receives the first charging request via the network, in step S740, the server determines whether the first charging station is in the list of the candidate charging stations. In some embodiments, the list of the candidate charging stations may be determined according to a moving route of a mobile device. That is, when the first charging station is one of the charging stations in the moving route of the corresponding mobile device, it means that the first charging station is in the list of the candidate charging stations. When the first charging station is not in the moving route of the corresponding mobile device, it means that the first charging station is not in the list of the candidate charging stations. When the first charging station is in the list of the candidate charging stations (Yes in step S740), in step S750, in response to the first charging request, the server instructs the first charging station to perform a first charging operation via the network. Then, in step S760, the server continuously obtains first charging state information corresponding to the first charging operation from the first charging station via the network, and calculates a first charging fee associated with the first identity account according to the first charging state information, wherein the first charging state information comprises a charging time and/or a charging amount. It should be noted that, in some embodiments, the server may calculate the latest first charging fee associated with the first identity account according to the received first charging state information in real time. In some embodiments, the server may calculate the final first charging fee associated with the first identity account according to the first charging state information when receiving a charging end signal of the charging operation. The present invention is not limited to any point in time for calculating the charging fee. That is, the user can use the mobile device to select a specific identity account through the application to start the charging operation at the electric vehicle charging station, and the server can calculate the charging fee associated with the selected identity account. When the first charging station is not in the list of the candidate charging stations (No in step S740), in step S770, the server generates a warning message, or prohibits the first charging operation to be performed. That is, when a charging request of the enterprise account is generated at a charging station within a non-specific area, it will be regarded as abnormal charging, and a warning will occur or the charging operation will not be allowed, which can effectively prevent the enterprise account from being used to illegal charging.

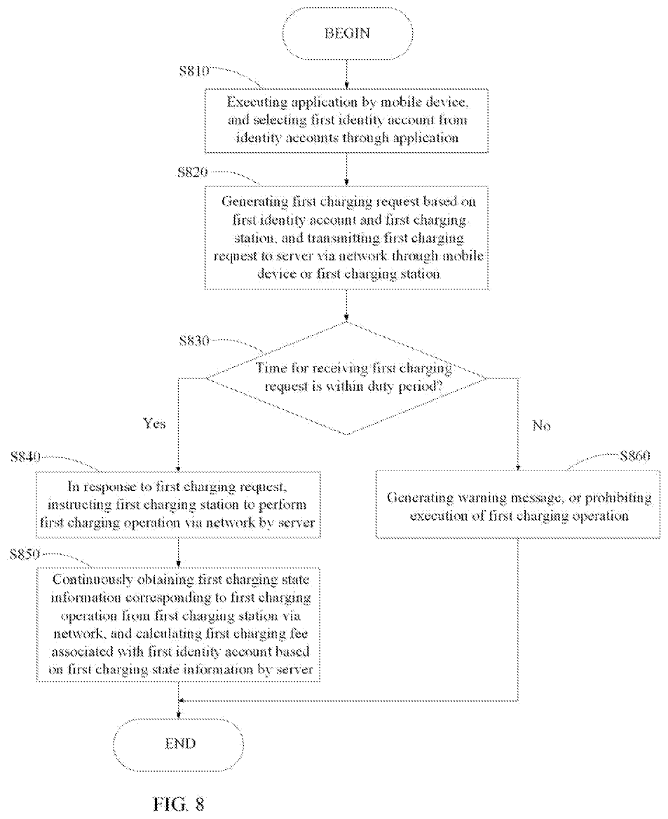

FIG. 8 is a flowchart of another embodiment of an electric vehicle charging management method capable of integrating multiple identities of the invention. The electric vehicle charging management method capable of integrating multiple identities of the invention is applicable to a mobile device, a plurality of charging stations, and a server connected with the respective charging stations via a network. In this embodiment, the first identity account belongs to an enterprise account, and the charging operation of the enterprise account during the off-duty period will generate warning information or cannot be executed.

In step S810, an application is executed on the mobile device, and a first identity account is selected from a plurality of identity accounts through the application. It should be noted that, in some embodiments, the application may include a plurality of identity accounts corresponding to a user, and the identity accounts at least include a first identity account and a second identity account. It is reminded that, in some embodiments, the above-mentioned identity account can be preset in the application. In this embodiment, the first identity account belongs to an enterprise account of an enterprise, and the charging fee of the first identity account is paid by the enterprise. In step S820, a first charging request is generated according to the first identity account and a first charging station among the electric vehicle charging stations, and the first charging request is transmitted to the server via the network through the mobile device or the first charging station. In some embodiments, the mobile device may execute an application to select a first charging station through the application, thereby generating the first charging request including the charging station identification code of the selected charging station and the first identity account, and transmit the first charging request to the server via the network. It must be noted that, in some embodiments, the mobile device can scan a quick response code, such as a QR code, on the first charging station, and generate the first charging request comprising the charging station identification code of the first charging station and the first identity account according to the quick response code. The first charging request is sent to the server via the network. In some embodiments, the mobile device can select the first charging station through the application, so as to generate the first charging request comprising the charging station identification code of the selected charging station and the first identity account, and transmit the first charging request to the server via the network. After the server receives the first charging request via the network, in step S830, the server determines whether a time for receiving the first charging request falls within a duty period. For example, in one embodiment, the duty period may include a specific period, such as a work period from 9:00 am to 5:00 pm, and if the time when the first charging request is received is between 9:00 am and 5:00 pm, it is determined that the time for receiving the first charging demand falls within the duty period, but the present invention is not limited to this. When the time for receiving the first charging request falls within the duty period (Yes in step S830), then steps S840 and S850 are executed. in step S840, in response to the first charging request, the server instructs the first charging station to perform a first charging operation via the network. Then, in step S850, the server continuously obtains first charging state information corresponding to the first charging operation from the first charging station via the network, and calculates a first charging fee associated with the first identity account according to the first charging state information, wherein the first charging state information comprises a charging time and/or a charging amount. Similarly, in some embodiments, the server may calculate the latest first charging fee associated with the first identity account according to the received first charging state information in real time. In some embodiments, the server may calculate the final first charging fee associated with the first identity account according to the first charging state information when receiving a charging end signal of the charging operation. The present invention is not limited to any point in time for calculating the charging fee. That is, the user can use the mobile device to select a specific identity account through the application to start the charging operation at the electric vehicle charging station, and the server can calculate the charging fee associated with the selected identity account. When the time for receiving the first charging request does not fall within the duty period (No in step S830), in step S860, the server generates a warning message or prohibits the first charging operation to be performed. That is, when an individual uses an enterprise account for charging during non-duty/off-duty hours, it will be regarded as abnormal charging, and a warning will occur or the charging operation will not be allowed, which can effectively prevent the enterprise account from being used to steal charging.

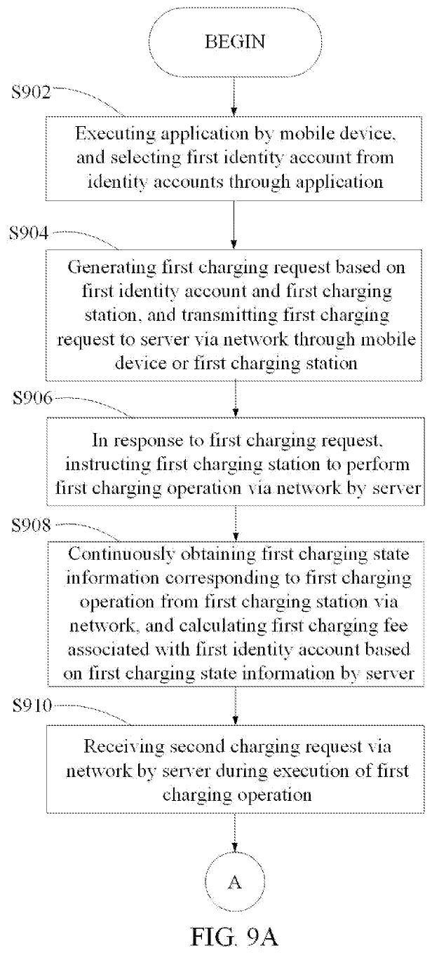

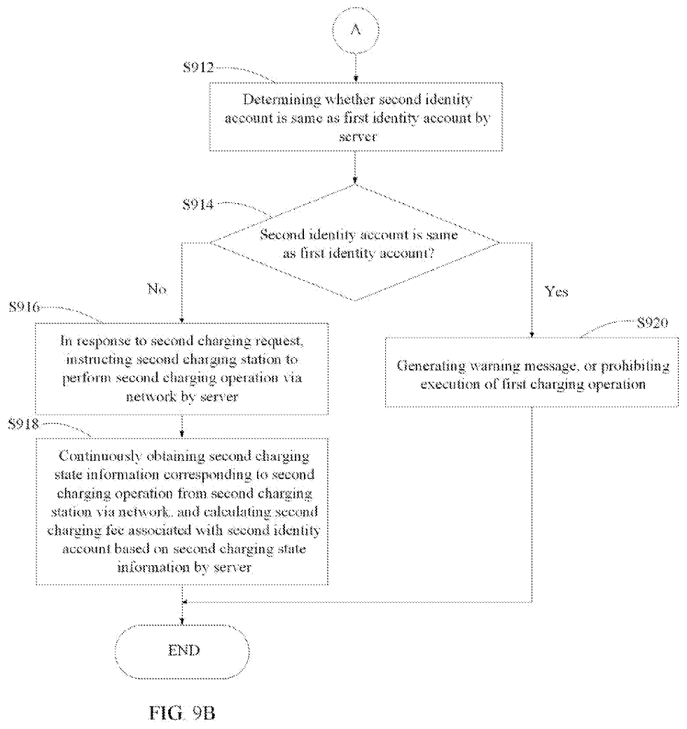

FIGS. 9A and 9B show a flowchart of another embodiment of an electric vehicle charging management method capable of integrating multiple identities of the invention. Please refer together with FIG. 9A and FIG. 9B. The electric vehicle charging management method capable of integrating multiple identities of the invention is applicable to a mobile device, a plurality of charging stations, and a server connected with the respective charging stations via a network. In this embodiment, the first identity account belongs to an enterprise account and when a second charging request from the same enterprise account at a different charging station is simultaneously received during the execution of the first charging operation, the charging operation corresponding to the second charging request will generate a warning message or cannot be executed.

In step S902, an application is executed on the mobile device, and a first identity account is selected from a plurality of identity accounts through the application. It should be noted that, in some embodiments, the application may include a plurality of identity accounts corresponding to a user, and the identity accounts at least include a first identity account and a second identity account. It is reminded that, in some embodiments, the above-mentioned identity account can be preset in the application. In this embodiment, the first identity account belongs to an enterprise account of an enterprise, and the charging fee of the first identity account is paid by the enterprise. In step S904, a first charging request is generated according to the first identity account and a first charging station among the electric vehicle charging stations, and the first charging request is transmitted to the server via the network through the mobile device or the first charging station. In some embodiments, the mobile device may execute an application to select a first charging station through the application, thereby generating the first charging request including the charging station identification code of the selected charging station and the first identity account, and transmit the first charging request to the server via the network. It must be noted that, in some embodiments, the mobile device can scan a quick response code, such as a QR code, on the first charging station, and generate the first charging request comprising the charging station identification code of the first charging station and the first identity account according to the quick response code. The first charging request is sent to the server via the network. In some embodiments, the mobile device can select the first charging station through the application, so as to generate the first charging request comprising the charging station identification code of the selected charging station and the first identity account, and transmit the first charging request to the server via the network. After the server receives the first charging request via the network, in step S906, in response to the first charging request, the server instructs the first charging station to perform a first charging operation via the network. Then, in step S908, the server continuously obtains first charging state information corresponding to the first charging operation from the first charging station via the network, and calculates a first charging fee associated with the first identity account according to the first charging state information, wherein the first charging state information comprises a charging time and/or a charging amount. Similarly, in some embodiments, the server may calculate the latest first charging fee associated with the first identity account according to the received first charging state information in real time. In some embodiments, the server may calculate the final first charging fee associated with the first identity account according to the first charging state information when receiving a charging end signal of the charging operation. The present invention is not limited to any point in time for calculating the charging fee. That is, the user can use the mobile device to select a specific identity account through the application to start the charging operation at the electric vehicle charging station, and the server can calculate the charging fee associated with the selected identity account. In step S910, during the execution of the first charging operation, the server receives a second charging request via the network, wherein the second charging request is generated according to a second identity account and a second charging station among the electric vehicle charging stations. Then, in step S912, the server determines whether the second identity account is the same as the first identity account. When the second identity account is different from the first identity account (No in step S914), then steps S916 and S918 are executed. In step S916, in response to the second charging request, the server instructs the second charging station to perform a second charging operation via the network. Then, in step S918, the server continuously obtains the second charging state information corresponding to the second charging operation from the second charging station via the network, and calculates the second charging fee associated with the second identity account according to the second charging state information, wherein the second charging state information comprises a charging time and/or a charging amount. Similarly, in some embodiments, the server may calculate the latest second charging fee associated with the second identity account according to the received second charging state information in real time. In some embodiments, the server may calculate the final second charging fee associated with the second identity account according to the second charging state information when receiving a charging end signal of the corresponding charging operation. The present invention is not limited to any point in time for calculating the charging cost. That is, the server can separately calculate the charging fees associated with different identity accounts. When the second identity account matches the first identity account (Yes in step S914), in step S920, the server generates a warning message, or prohibits the second charging operation on the second charging station to be performed. That is, the same identity account is only allowed to perform a single charging operation at a time. That is, if the same enterprise account is used for charging operation at the same time, it will be regarded as abnormal charging, and a warning will occur or the charging operation will not be allowed to execute, which can effectively prevent the enterprise account from being used to steal charging.

In some embodiments, during the execution of the first charging operation, the server may further receive a third charging request via the network, wherein the third charging request is generated according to a third identity account and a third charging station among the electric vehicle charging stations. The server determines whether the third identity account belongs to the enterprise account, and when the third identity account belongs to the enterprise account, associates a third charging fee of a third charging operation corresponding to the third charging request to the enterprise account, and periodically generates the billing information of the corresponding enterprise account according to at least the first charging fee and the third charging fee. That is, the charging charges belonging to the same enterprise account will be counted together and the billing information of the corresponding enterprise account will be generated periodically. In some embodiments, the user may include a fourth identity account and the fourth identity account is a vehicle account corresponding to the vehicle number of the first electric vehicle, wherein the charging fees belonging to the same vehicle account will be counted together to periodically generate the billing information corresponding to the first electric vehicle.

Therefore, the electric vehicle charging management methods and systems of the present invention can integrate multiple identity accounts of individual users to manage electric vehicle charging operations and charging fees, so as to facilitate users to perform charging operations, thereby improving the user's ability to fluency and satisfaction in using related services. In addition, for enterprises, the charging operation of the corresponding enterprise account can generate a reminder or prohibit the execution of the charging operation when specific abnormal charging conditions such as personal non-duty hours and non-specific area charging are triggered, which can effectively protect the business owner and avoid the enterprise account from being used to steal charging.

Electric vehicle charging management methods capable of integrating multiple identities, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. An electric vehicle charging management method capable of integrating multiple identities, which is applicable to a mobile device, a plurality of electric vehicle charging stations, and a server coupled with the respective electric vehicle charging stations via a network, comprising:
executing an application by the mobile device, and selecting a first identity account from a plurality of identity accounts through the application;
generating a first charging request according to the first identity account and a first charging station, and transmitting the first charging request to the server via the network through the mobile device or the first charging station;
in response to the first charging request, instructing the first charging station to perform a first charging operation via the network by the server; and
continuously obtaining first charging state information corresponding to the first charging operation from the first charging station via the network, and calculating a first charging fee associated with the first identity account based on the first charging state information by the server, wherein the first charging state information comprises a charging time or a charging amount.

2. The method of claim 1, further comprising:
determining whether the first identity account belongs to an enterprise account or a personal account by the server; and
associating the first charging fee with the enterprise account, and periodically generating billing information corresponding to the enterprise account according to at least the first charging fee when the first identity account belongs to the enterprise account.

3. The method of claim 2, further comprising a step of providing a payment interface for setting payment information for the first charging fee before or after the first charging operation is performed when the first identity account belongs to the personal account.

4. The method of claim 2, further comprising a step of paying the first charging fee according to a stored value amount or payment information by the server when the first identity account belongs to the personal account.

5. The method of claim 2, further comprising:
providing a list of candidate charging stations, and determining whether the first charging station is in the list of the candidate charging stations; and
generating a warning message, or prohibiting the execution of the first charging operation when the first charging station is not in the list of the candidate charging stations.

6. The method of claim 5, wherein the candidate charging stations are determined according to a moving route corresponding to the mobile device.

7. The method of claim 2, further comprising:
determining whether a time for receiving the first charging request falls within a duty period; and
generating a warning message, or prohibiting the execution of the first charging operation when the time for receiving the first charging request does not fall within the duty period.

8. The method of claim 2, further comprising:
receiving a second charging request via the network by the server during the execution of the first charging operation, wherein the second charging request is based on a second identity account and a second charging station among the electric vehicle charging stations;
determining whether the second identity account is the same as the first identity account by the server; and
generating a warning message, or prohibiting the execution of the second charging operation on the second charging station when the second identity account is the same as the first identity account.

9. The method of claim 2, further comprising:
receiving a third charging request via the network by the server, wherein the third charging request is generated according to a third identity account and a third charging station among the electric vehicle charging stations;
determining whether the third identity account belongs to the enterprise account by the server; and
associating a third charging fee for a third charging operation corresponding to the third charging request to the enterprise account, and periodically generating the billing information corresponding to the enterprise account according to at least the first charging fee and the third charging fee when the third identity account belongs to the enterprise account.

10. An electric vehicle charging management system capable of integrating multiple identities, comprising:
a mobile device executing an application, and selecting a first identity account from a plurality of identity accounts through the application;
a plurality of electric vehicle charging stations; and
a server coupling with the respective electric vehicle charging stations via a network, receiving a first charging request which is generated according to the first identity account and a first charging station among the electric vehicle charging stations, in response to the first charging request, instructing the first charging station to perform a first charging operation via the network, continuously obtaining first charging state information corresponding to the first charging operation from the first charging station via the network, and calculating a first charging fee associated with the first identity account based on the first charging state information, wherein the first charging state information comprises a charging time or a charging amount.

11. The system of claim 10, wherein the server further determines whether the first identity account belongs to an enterprise account or a personal account, associates the first charging fee with the enterprise account, and periodically generates billing information corresponding to the enterprise account according to at least the first charging fee when the first identity account belongs to the enterprise account.

12. The system of claim 11, wherein the server further provides a payment interface for setting payment information for the first charging fee before or after the first charging operation is performed when the first identity account belongs to the personal account.

13. The system of claim 11, wherein the server further pays the first charging fee according to a stored value amount or payment information when the first identity account belongs to the personal account.

14. The system of claim 11, wherein the server further provides a list of candidate charging stations, determines whether the first charging station is in the list of the candidate charging stations, and generates a warning message, or prohibits the execution of the first charging operation when the first charging station is not in the list of the candidate charging stations.

15. The system of claim 14, wherein the candidate charging stations are determined according to a moving route corresponding to the mobile device.

16. The system of claim 11, wherein the server further determines whether a time for receiving the first charging request falls within a duty period, and generates a warning message, or prohibits the execution of the first charging operation when the time for receiving the first charging request does not fall within the duty period.

17. The system of claim 11, wherein the server further receives a second charging request via the network during the execution of the first charging operation, wherein the second charging request is based on a second identity account and a second charging station among the electric vehicle charging stations, determines whether the second identity account is the same as the first identity account by the server, and generates a warning message, or prohibits the execution of the second charging operation on the second charging station when the second identity account is the same as the first identity account.

18. The system of claim 11, wherein the server further receives a third charging request via the network, wherein the third charging request is generated according to a third identity account and a third charging station among the electric vehicle charging stations, determines whether the third identity account belongs to the enterprise account by the server, associates a third charging fee for a third charging operation corresponding to the third charging request to the enterprise account, and periodically generates the billing information corresponding to the enterprise account according to at least the first charging fee and the third charging fee when the third identity account belongs to the enterprise account.

19. A machine-readable storage medium comprising a computer program, which, when executed, causes a device to perform an electric vehicle charging management method capable of integrating multiple identities, which is applicable to a mobile device, a plurality of electric vehicle charging stations, and a server coupled with the respective electric vehicle charging stations via a network, wherein the method comprises:
executing an application by the mobile device, and selecting a first identity account from a plurality of identity accounts through the application;
generating a first charging request according to the first identity account and a first charging station, and transmitting the first charging request to the server via the network through the mobile device or the first charging station;
in response to the first charging request, instructing the first charging station to perform a first charging operation via the network by the server; and
continuously obtaining first charging state information corresponding to the first charging operation from the first charging station via the network, and calculating a first charging fee associated with the first identity account based on the first charging state information by the server, wherein the first charging state information comprises a charging time or a charging amount.
